(19) United States
(12) Patent Application Publication
(10) Pub. No.: US 2003/0088875 A1
(43) Pub. Date: May 8, 2003

(54) Simultaneous viewing of video files on networked computer systems

(76) Inventors: Lance J. Gay, Torrance, CA (US); Timothy A. Yokote, Torrance, CA (US); Thomas J. Gritzmacher, Torrance, CA (US)

Correspondence Address: PATENT COUNSEL, TRW INC., S & E LAW DEPT., ONE SPACE PARK, BLDG. E2/6051, REDONDO BEACH, CA, 90278, US

(21) Appl. No.: 10/005,768

(22) Filed: Nov. 8, 2001

(51) Int. Cl. H04N 7/173; H04N 7/18; H04N 9/47

(52) U.S. Cl. 725/88; 725/102; 725/105

(57) ABSTRACT

A method is provided that includes viewing at least one frame of a video file at a first location, viewing the at least one frame of the video file at a second location and transmitting a command from the first location to the second location regarding a control operation of the video file.

### BACKGROUND OF THE INVENTION

1. Field of the Invention

This invention relates to a video data, and more particularly relates to synchronous operations among a plurality of networked computer systems.

2. Discussion of the Related Art

Numerous people may desire to simultaneously view a video or video file. This may be especially true in the motion picture business so that people such as the director, producer and editors may view portions of a video for various reasons including editing. This may require that the plurality of people are all located at one area to view the video on one screen. This may be difficult for geographic reason. Alternatively, the plurality people may be at different locations with each location having a different video screen. This would make it extremely cumbersome to simultaneously view the video since voice communications across telephone lines would be necessary to discuss various procedures such as advancing the video to a specific frame or pausing the video.

### SUMMARY OF THE INVENTION

Embodiments of the present invention may include providing a video on a first screen of a first system, transmitting a command signal from the first system to a second system and performing an operation corresponding to the transmitted command signal at the first system. The method may also include performing an operation corresponding to the transmitted command at the second system.

The operation may be performed at the first system substanstantially simultaneously as the operation is performed at the second system.

The command signal may represent one of stop, play, forward, reverse and pause of the video. The command signal may also include a pointer coordinate position of a video screen representing specific coordinates of the video screen or a frame number of the video representing a specific frame number of the video.

Embodiments of the present invention may also include displaying a video on a first video screen, displaying the video on a second video screen, and simultaneously performing at least one operation on the first video screen and the second video screen by transmitting command signals across a communications network.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and the invention is not limited thereto.

The following represents brief descriptions of the drawings in which like reference numerals represent like elements and wherein:

FIG. 1 illustrates computer systems coupled together by a communications network;

FIG. 2 illustrates a block diagram of a computer system;

FIG. 3 illustrates a software hierarchy according to an example embodiment of the present invention;

FIG. 4 illustrates a command format for communications according to an example embodiment of the present invention;

FIG. 5 is a flowchart showing operations of an initialization process according to an example embodiment of the present invention;

FIG. 6 is a flowchart showing operations to perform a video command according to an example embodiment of the present invention;

FIG. 7 illustrates operations of an initialization process according to an example embodiment of the present invention;

FIG. 8 illustrates operations of various video commands according to an example embodiment of the present invention; and

FIG. 9 illustrates a display screen according to an example embodiment of the present invention.

### DETAILED DESCRIPTION OF PREFERRED EMBODIMENTS

In the following detailed description, like reference numerals and characters may be used to designate identical, corresponding, or similar components in differing drawing figures.

Embodiments of the present invention may relate to multiple computer systems that are spread over a wide geographic area and are coupled together by a computer network so as to simultaneously view a similar video file on their respective computer systems and synchronize playback of the video file to enhance collaboration. Embodiments of the present invention may be described with respect to different collaborators. Collaborators are intended to identify users working on a similar project and each having access to a computer system having synchronous player software as will be described below.

Each collaborator may have a video file residing locally on his or her own computer system and have a software program (hereafter called a synchronous player, synchronous player program or synchronous player application) simulate a set of video controls on each video screen. Thus, when one collaborator pauses the video at a certain frame, the video may pause at the same frame on the other collaborator's computers. The collaborators (such as motion picture directors and video editors) may then discuss their views on the various portions of the video file if they are coupled via an audio or video teleconference, for example. The computer mouse cursor of each of the collaborators' computers may also be synchronized. Thus, when one of the collaborators moves his/her mouse to point to a specific location in the video screen, the mouse pointer on the other collaborators' computers may also be moved to the same location on their respective video screens. This may be used to indicate a part of the video frame that the initial collaborator wishes to discuss or identify.

The synchronous player may be a computer program (also hereafter called a computer application) running on a computer workstation or a plurality of programs running on a plurality of workstations. The program, which may run on each collaborator's computer, may play encoded video files. The video file may thereby be displayed on the video screen of each of the video workstations. A set of icons may be displayed on a video screen, similar in appearance to the controls on a video cassette recorder (such as pause, play, forward, and reverse, for example) and incorporate the same functions as a video cassette recorder. Functionally, when one collaborator pushes (or virtually pushes) one of the icon buttons on the computer screen, a command (or commands) may be sent over the computer network (such as the internet, a local network or a phone line, for example) to the other collaborators' computers (hereafter also called remote collaborators' computers) specifying a command related to the button or icon that was pressed. The computer program running on the remote collaborators' computers may then execute the same action (such as pause or play of the video). Thus, the video playing on each of the set of computers may remain synchronized (or relatively synchronized) with respect to each other. Similarly, when one of the collaborators moves his/her respective mouse cursor, then a command (or commands) may be sent over the network to the other computers instructing the other computers to move their mouse cursor to the same location on the displayed video screen.

The control messages (or control signals) sent between the collaborating computers may be relatively small (i.e., less than 100 bytes) and thus may consume only a small amount of network bandwidth and may be transmitted in a timely fashion over a low-bandwidth computer network. As one example, the computer program may be implemented using a Microsoft Windows operating system and a Microsoft Windows Media Player application. Embodiments of the present invention may also be implemented in a wide variety of computer platforms.

FIG. 1 illustrates three computer systems coupled together by a communications network. For example, FIG. 1 illustrates a first computer system 10, a second computer system 20 and a third computer system 30 all coupled together by a communications network 50. The communications network 50 may be any of a number of well known networks such as the internet, a local area network or a phone line network. Each of the computer systems 10, 20 and 30 may include a similar video file stored therein and a synchronous player program installed or running on the respective computer system.

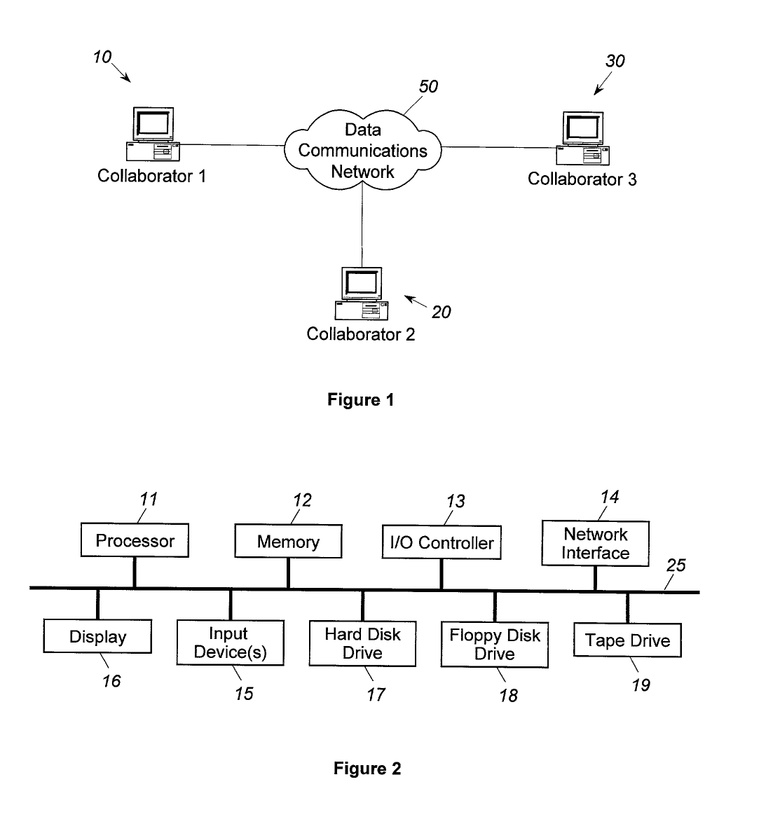

FIG. 2 illustrates a block diagram of one example computer system. Each of the remaining computer systems may include similar features. The computer system may include at least one processing unit 11, a main memory unit 12 for storing programs and/or data, and input/output controller 13, a network interface 14, one or more input devices 15 such as a keyboard and a mouse, a display device (or video screen) 16, a fixed or hard disk drive unit 17, a floppy disk drive unit 18, a tape drive unit 19, and a data bus 25 coupling these components to allow communication therebetween.

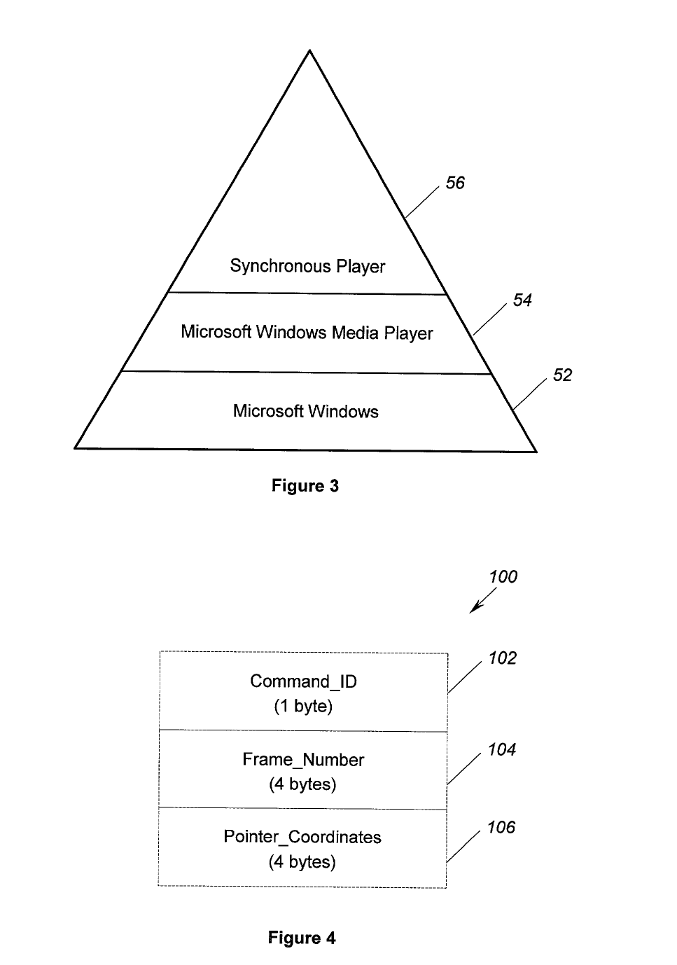

FIG. 3 illustrates a software hierarchy according to an example embodiment of the present invention. Other embodiments and configurations are also within the scope of the present invention. More specifically, FIG. 3 illustrates that a synchronous player application (or program) 56 may be implemented through use of a Microsoft Windows Media Player 54 that runs using Microsoft Windows 52.

FIG. 4 illustrates a command format for the synchronous player application according to an example embodiment of the present invention. Other embodiments and configurations of the command format are also within the scope of the present invention. More specifically, FIG. 4 illustrates a command 100 that may include a command ID section 102, a frame number section 104, and a pointer coordinate section 106. The command ID section 102 may be a one byte section of the command 100, the frame number section 104 may be a four byte section of the command 100 and the pointer coordinate section 106 may be a four byte section of the command 100. Accordingly, the command 100 shown in FIG. 4 may be approximately nine bytes long and may be considered a relatively small control message. Other lengths and number of bytes for each of the sections 102, 104 and 106 and the overall command are also within the scope of the present invention. The command 100 may be transmitted among the first computer system 10, the second computer system 20 and the third computer system 30 using the communications network 50 shown in FIG. 1.

The command 100 may indicate a specific command relative to a specific video file provided on each of the computer systems 10, 20 and 30. As one example, the command ID section 102 may be a one byte section where each respective bit of the byte may indicate a specific operation or command. For example, bit one may correspond to a play command, bit two may correspond to a pause command, bit three may correspond to a stop command, bit four may correspond to a fast-forward command, bit five may correspond to a rewind command, bit six may correspond to proceeding (or advancing) to a specific frame command and bit seven may correspond to a mouse pointer command. Each of the bits may be HIGH or LOW to indicate whether it corresponds to one of the specific commands. Other arrangements and configurations of bit numbers and the respective commands are also within the scope of the present invention. Additionally, other commands are also within the scope of the present invention.

The frame number section 104 may be a four byte number applicable when the command ID section 102 indicates a command to proceed (or advance) to a specific frame number. The frame number section 104 may specify a video frame number in the video file that may be used to position the video file on each of the collaborators' screens at a similar and specific video frame.

The pointer coordinate section 106 may be a four byte number applicable when the command ID section 102 indicates the mouse pointer command. The pointer coordinate section 105 may specify X and Y coordinates at which the mouse pointer is positioned on the video screen of the collaborator sending the command. Accordingly, the pointer coordinate section 106 may be used to position the mouse at a same position on each of the video screens of the other collaborators.

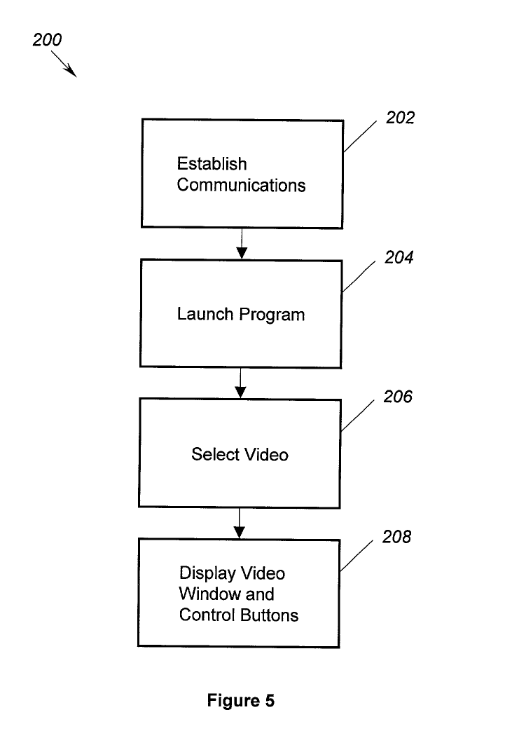

FIG. 5 is a flowchart 200 showing operations of an initialization process according an example embodiment of the present invention. Other embodiments, operations and orders of operations for the initialization process are also within the scope of the present invention. More specifically, in block 202, a communications link (or path) may be established among the respective collaborators across the network. For example, in FIG. 1 the communications link may be established among each of the computer systems 10, 20 and 30 by use of the communications network 50. In block 204, the synchronous player program may be launched or initialized at each of the computer systems 10, 20 and 30. In block 206, a specific video file may be selected at one of the computer systems 10, 20 or 30. The computer system that selects the video file may hereafter also be referred to as the originator. The originator may also be considered the computer system that begins the initialization process by first launching the synchronous player program. For example, the computer system 10 may select an appropriate video (such as video A) and communicate the selection of that respective video across the communications network 50 to each of the computer systems 20 and 30. If necessary, the selected video (such as video A) may be transmitted across the communications network 50 to each of the computer systems 20 and 30. This insures that each of the computer systems 10, 20 and 30 are viewing a similar video file. In block 208, each of the computer systems 10, 20 and 30 may display a video window and control buttons (or icons) on the respective video screens. The display may be based on the synchronous player program running on each of the computer systems 10, 20 and 30.

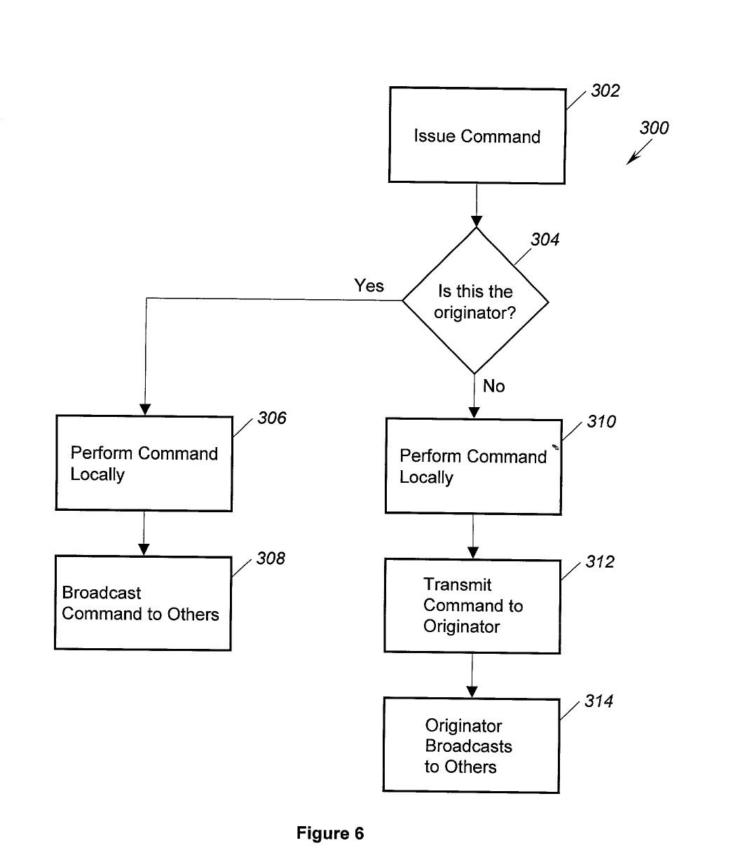

FIG. 6 is a flowchart 300 showing operations to perform one of the video commands according to an example embodiment of the present invention. Other embodiments, operations and orders of operations are also within the scope of the present invention. More specifically, FIG. 6 relates to a video command that may be transmitted among the first computer system 10, the second computer system 20 and the third computer system 30 after the initialization process. In one example embodiment, a command (such as play, pause, fast-forward, rewind, etc.) may be issued in block 302. The issuance of the command may be accomplished by one of the collaborators pushing a button (or virtually pushing or clicking a button or icon) on the video screen to commence an operation. In at least one embodiment, the synchronous player program may then determine whether the issued command is from the originator in block 304. As discussed above, the originator may correspond to the initial computer system that selects the video file for the other computer systems. If the synchronous player program determines that the command was issued from the originator in block 304, then that command may be performed locally in block 306 and the command may be broadcast to the other systems in block 308. That is, if the command originates in the computer system 10 (and the computer system 10 is the originator), then the command may be performed at the computer system 10 and then the command (having the command format) may be broadcast across the communications network 50 to the other computer systems (such as the computer system 20 and the computer system 30). This command may then be performed at each of those respective computer systems. On the other hand, if the command is issued by one of the computer systems other than the originator, then that command may be performed locally at the computer in block 310 and the command may then be transmitted back to the originator in block 312. For example, if the command is issued by the computer system 20, then the command may be performed at the computer system 20 and transmitted to the first computer system 10 thru the communications network 50. Then in block 314, the originator may broadcast the command to the computer systems other than the computer system that issued the command. For example, upon receiving the command from the computer system 20, the originator (here the computer system 10) may broadcast the command to the computer system 30. The computer system 10 and the computer system 30 may perform the command. The command may also be broadcast to the computer system 20 which may be programmed to ignore the command if the computer system 20 has already executed the command. The computer system 10 may perform the command either prior to broadcasting the command to the computer system 30, during the broadcast of the command to the computer system 30 or immediately after broadcasting the command to the computer system 30.

In another example embodiment, if the command is issued by a system other than the originator, then that command may be transmitted to the originating system (i.e., the originator) without the command being initially performed at the local computer system that issued the command. In this example, the originator may then broadcast the command to all of the other computer systems. For example, if the computer system 20 issues a command but is not the originator, then the computer system 20 may transmit the command back to the originator (such as the computer system 10) which may then broadcast the command to the other computer systems (such as the computer system 20 and the computer system 30). The computer system 20 and 30 may thereby perform the command after receiving the command from the originator.

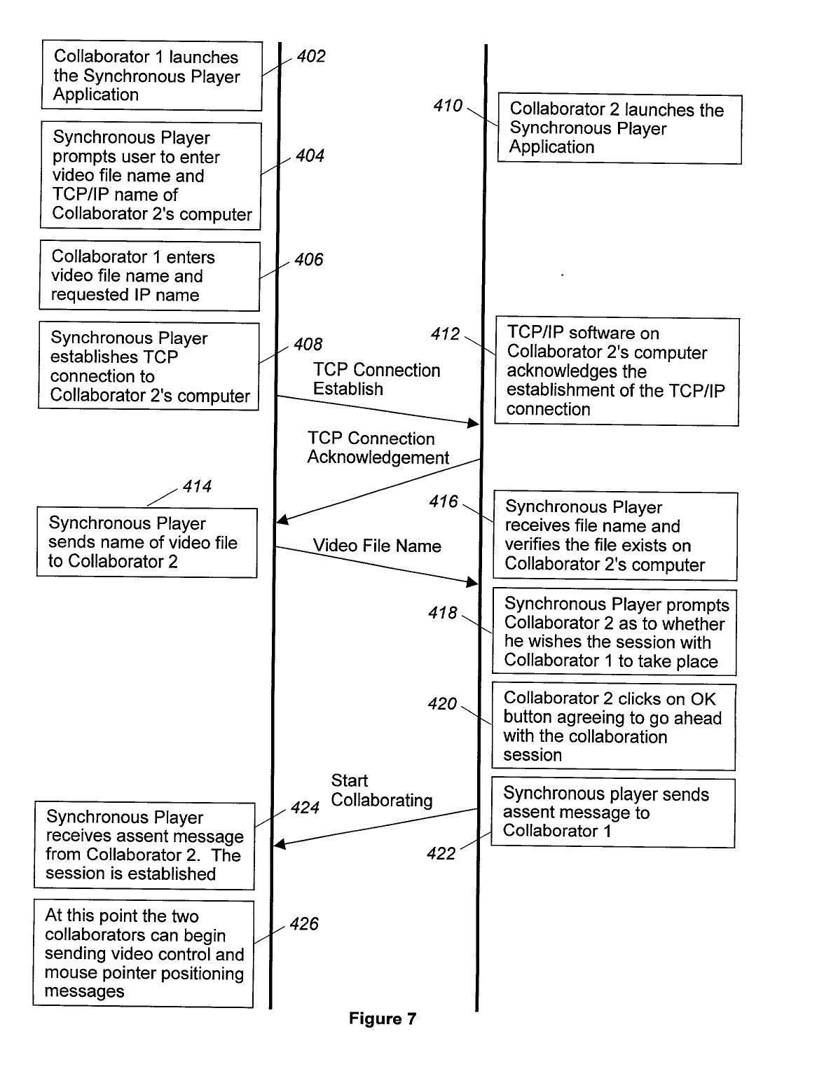

FIG. 7 illustrates operations of an initialization process according to another example embodiment of the present invention. Other embodiments for the initialization process are also within the scope of the present invention. More specifically, FIG. 7 illustrates one specific example of how an initialization may occur between a first collaborator and a second collaborator. For ease of illustration, the first collaborator may be considered the originator (such as the computer system 10) and the second collaborator may be considered the non-originating computer system (such as the computer system 20). While FIG. 7 only shows communications between two computer systems, one skilled in the art would understand that the communications may be broadcast to more than one computer system.

In block 402, the first collaborator may launch (or start) the synchronous player application at his/her computer system. Similarly, the second collaborator may launch (or start) the synchronous player application at his/her system in block 410. The order that each of the computer systems launches the respective synchronous player applications is not material. That is, each of the collaborators merely needs to launch or start the respective synchronous player applications so they are both running. In block 404, the synchronous player program on the first collaborator may prompt the user to enter a video file name and a TCP/IP name or address of the second collaborator's computer system. In block 406, the first collaborator may enter the desired video file name and a requested TCP/IP name as requested by the synchronous player program. Then, in block 408, the synchronous player program may establish a TCP connection (i.e., TCP Connection Establish) to the second collaborator's computer. In block 412, the TCP/IP software on the second collaborator's computer may acknowledge the establishment of the TCP/IP connection (i.e., TCP Connection Establish). Thereafter, the synchronous player program on the first collaborator's computer system may send the name of the video file (i.e., Video File Name) to the second collaborator in block 414. In block 416, the synchronous player program receives the file name and verifies that the video file exists on the second collaborator's computer. In one example embodiment, the synchronous player program on the second collaborator's computer may prompt the second collaborator (in block 418) as to whether he/she wishes to take place in the communications session with the first collaborator. In block 420, the second collaborator may click (or virtually click) on an OK button (or similar type of button or icon) to agree to proceed with the collaboration session. The synchronous player program of the second collaborator may send an assent message (i.e., Start Collaborating) to the first collaborator in block 422. The synchronous player program on the first collaborator may receive the assent message from the second collaborator in block 424 and establish the session. Then, in block 426, the two collaborators may begin sending video control and mouse pointer positioning messages (i.e., commands) in accordance with the embodiments of the present invention.

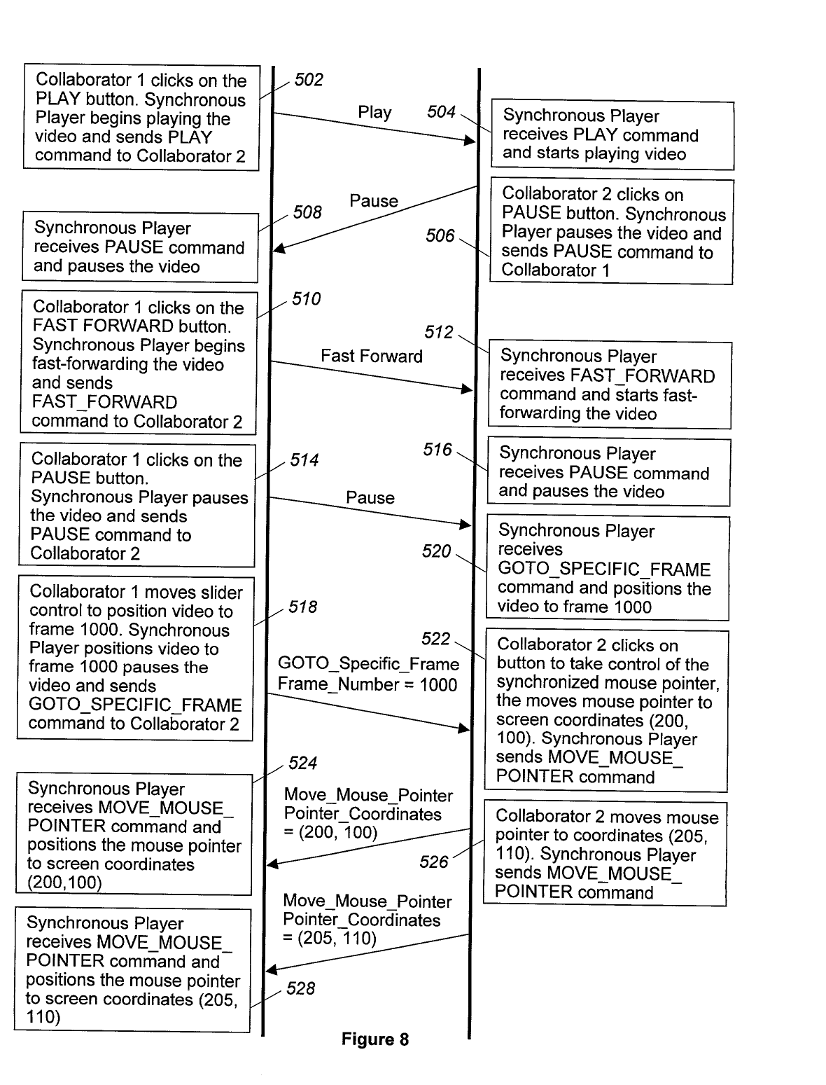

FIG. 8 illustrates operations to perform various video commands according to example embodiments of the present invention. Other embodiments and operations to perform the commands are also within the scope of the present invention. More specifically, FIG. 8 shows several examples of different commands that may be transmitted among respective computer systems that are running the synchronous player application. The ordering and numbering of the respective operations shown in FIG. 8 is not intended to show any order of operations but is merely intended to label the respective operations.

More specifically, in block 502 the first collaborator may click (or virtually click) on a play button (or similar button or icon) on his or her video screen. The synchronous player application may begin playing the video on the first collaborator's screen and transmit the play command to the second collaborator. The synchronous player program on the second collaborator may receive the play command and begin playing the video in block 504.

In another command, the second collaborator may click (or virtually click) on the pause button (or similar button or icon) and the synchronous player program may thereby pause the video on the second collaborator's screen and transmit the pause command to the first collaborator in block 506. In block 508, the synchronous player program on the first collaborator may receive the pause command and pause the video.

In yet another command, the first collaborator may click (or virtually click) on the fast-forward button (or similar button or icon) in block 510. The synchronous player program of the first collaborator may begin fast-forwarding the video on the first collaborator's screen and transmit the fast-forward command to the second collaborator in block 510. In block 512, the synchronous player program on the second collaborator may receive the fast-forward command and start fast-forwarding the video on the second collaborator's screen in block 512.

In still yet another command, the first collaborator may click (or virtually click) on the pause button (or similar button or icon) in block 514 and the synchronous player program may thereby pause the video (on the first collaborator's screen) and transmit the pause command to the second collaborator in block 514. The synchronous player program of the second collaborator may receive the pause command and pause the video on the second collaborator's screen in block 516.

In another command, the first collaborator may move (or virtually move) a slider control (such as on the video screen) to position the video at a frame number (such as frame 1000). For example, the first collaborator may position the video (using the slider control) at the frame 1000 and pause the video. The synchronous player program may then transmit a GOTO_SPECIFIC_FRAME command and FRAME_NUMBER=1000 signal to the second collaborator in block 518. In block 520, the synchronous player program of the second collaborator may receive the GOTO_SPECIFIC_FRAME command and the FRAME_NUMBER=1000 signal and position the video on the second collaborator's computer at frame 1000.

In still yet another command, in block 522, the second collaborator may click (or virtually click) on a button or icon to take control of the synchronized mouse pointer and position the mouse pointer at specific screen coordinates such as (200, 100). The synchronous player program of the first collaborator may transmit a MOVE_MOUSE_POINTER command and indicate the POINTER COORDINATES=(200,100). In block 524, the synchronous player program of the first collaborator may receive the MOVE_MOUSE_POINTER command and the POINTER_COORDINATES=(2000,100) signal and appropriately position the mouse pointer at screen coordinates (200, 100).

In yet an even further command, in block 526, the second collaborator may move the mouse pointer to coordinates (such as coordinates 205, 110). The synchronous player program of the second collaborator may then transmit the MOVE_MOUSE_POINTER command and POINTER_COORDINATES=(205,110) signal in block 526. In block 528, the synchronous player program at the first collaborator may receive the MOVE_MOUSE_POINTER command and the POINTER_COORDINATES=(205,110) signal and position the mouse pointer at the screen coordinates (205,110).

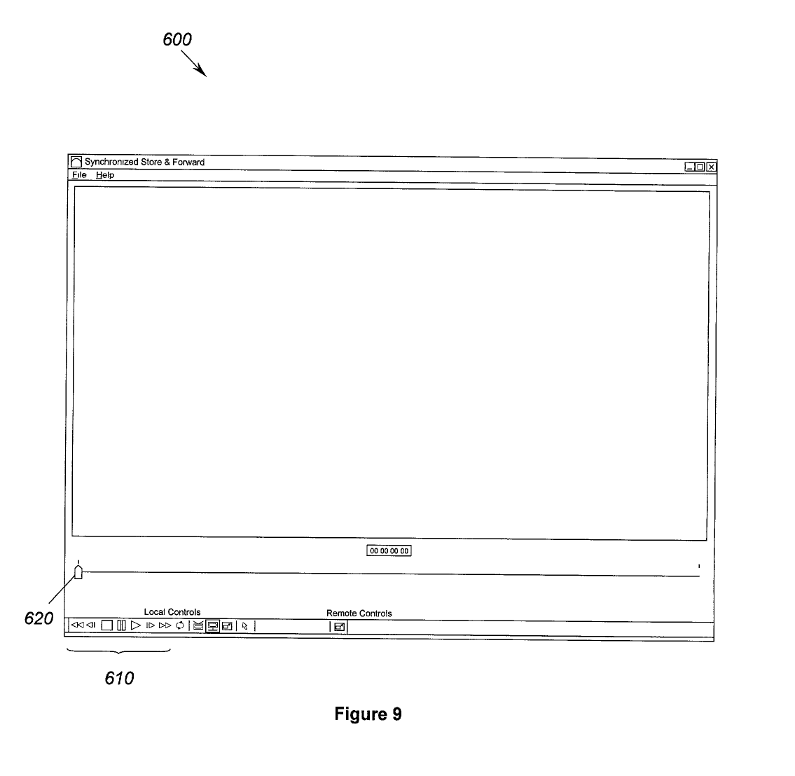

FIG. 9 illustrates a display screen 600 according to an example embodiment of the present invention. Other embodiments and configurations are also within the scope of the present invention. More specifically, FIG. 9 illustrates command keys 610 and a slider control 620 that may be used to issue appropriate commands as discussed above. Each of the keys 610 and the slider control 620 may be operated by use of a mouse or other type of input device such as the keyboard. The keys 610 may include various keys or icons including, but not limited to, pause, play, forward and reverse such as on a video cassette recorder. The screen may also display an area to indicate a specific frame number or a specific coordinate for a pointer.

Accordingly, embodiments of the present invention may include providing a video on a first screen of a first system, transmitting a command signal from the first system to a second system and performing an operation corresponding to the transmitted command signal at the first system. The method may also include performing an operation corresponding to the transmitted command at the second system.

Any reference in the above description to “one embodiment”, “an embodiment”, “example embodiment”, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the knowledge of one skilled in the art to effect such feature, structure, or characteristic in connection with other ones of the embodiments. Furthermore, for ease of understanding, certain method procedures may have been delineated as separate procedures; however, these separately delineated procedures should not be construed as necessarily order dependent in their performance. That is, some procedures may be able to be performed in an alternative ordering, simultaneously, etc.

Further, embodiments of the present invention or portions of embodiments of the present invention may be practiced as a software invention, implemented in the form of a machine-readable medium having stored thereon at least one sequence of instructions that, when executed, causes a machine to effect the invention. With respect to the term “machine”, such term should be construed broadly as encompassing all types of machines, e.g., a non-exhaustive listing including: computing machines, non-computing machines, communication machines, etc. Similarly, with respect to the term “machine-readable medium”, such term should be construed as encompassing a broad spectrum of mediums, e.g., a non-exhaustive listing including: magnetic medium (floppy disks, hard disks, magnetic tape, etc.), optical medium (CD-ROMs, DVD-ROMs, etc), etc.

A machine-readable medium includes any mechanism that provides (i.e., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

Although the present invention has been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A method comprising:
viewing at least one frame of a video file at a first location;
viewing said at least one frame of said video file at a second location; and
transmitting a command signal from said first location to said second location regarding a control operation of said video file.

2. The method of claim 1, further comprising performing said control operation of said video file at said first location.

3. The method of claim 2, further comprising performing said control operation of said video file at said second location.

4. The method of claim 3, wherein said control operation is performed at said first location substanstantially simultaneously as said control operation is performed at said second location.

5. The method of claim 1, wherein said command signal comprises one of stop, play, forward, reverse and pause of said video file.

6. The method of claim 1, wherein said command signal comprises a pointer coordinate position of a video screen.

7. The method of claim 1, wherein said command signal comprises a frame number of said video file.

8. A method comprising:
providing a video on a first screen of a first system;
transmitting a command signal from said first system to a second system;
performing an operation corresponding to said transmitted command signal at said first system; and
performing an operation corresponding to said transmitted command signal at said second system.

9. The method of claim 8, wherein said operation is performed at said first system substanstantially simultaneously as said operation is performed at said second system.

10. The method of claim 8, wherein said command signal represents one of stop, play, forward, reverse and pause of said video.

11. The method of claim 8, wherein said command signal comprises a pointer coordinate position of a video screen representing specific coordinates of said video screen.

12. The method of claim 8, wherein said command signal comprises a frame number of said video signal representing a specific frame number of said video.

13. A method comprising:
displaying a video on a first video screen;
displaying said video on a second video screen;
simultaneously performing at least one operation on said first video screen and said second video screen by transmitting at least one command signal across a communications network.

14. The method of claim 13, wherein said at least one operation is performed on said first video screen substanstantially simultaneously as said at least one operation is performed on said second video screen.

15. The method of claim 13, wherein said at least one command signal comprises one of stop, play, forward, reverse and pause of said video.

16. The method of claim 13, wherein said at least one command signal comprises a pointer coordinate position of a video screen representing specific coordinates of said video screen.

17. The method of claim 13, wherein said at least one command signal comprises a frame number of said video representing a specific frame number of said video.

18. A program storage device readable by machine, tangibly embodying a program of instructions executable by the machine to perform a method comprising:
transmitting a command signal from a first computer system to a second computer system regarding a first control operation of a video file;
performing said first control operation on said first computer system;
receiving a command signal from said second computer system regarding a second control operation of said video file; and
performing said second control operation on said first computer system.

19. The program storage device of claim 18, wherein said command signal comprises one of stop, play, forward, reverse and pause of said video file.

20. The program storage device of claim 18, wherein said command signal comprises a pointer coordinate position of a video screen.

21. The program storage device of claim 18, wherein said command signal comprises a frame number of said video file.

22. A computer system comprising at least one processing unit, at least a video display and at least one storage device, said storage device tangibly embodying a program of instructions executable by the processing unit to perform a method comprising:
transmitting a command signal from said computer system to another computer system regarding a first control operation of a video file;
performing said first control operation on said computer system;
receiving a command signal from said another computer system regarding a second control operation of said video file; and
performing said second control operation on said computer system.

23. The program storage device of claim 22, wherein said command signal comprises one of stop, play, forward, reverse and pause of said video file.

24. The program storage device of claim 22, wherein said command signal comprises a pointer coordinate position of said video display.

25. The program storage device of claim 22, wherein said command signal comprises a frame number of said video file.
